(19) United States
(12) Patent Application Publication
(10) Pub. No.: US 2022/0138527 A1
(43) Pub. Date: May 5, 2022

(54) PROCESS FOR PROCESSING DATA BY AN ARTIFICIAL NEURAL NETWORK WITH GROUPED EXECUTIONS OF INDIVIDUAL OPERATIONS TO AVOID SIDE-CHANNEL ATTACKS, AND CORRESPONDING SYSTEM

(71) Applicants: IDEMIA FRANCE, Courbevoie (FR); INSTITUT MINES TELECOM, Palaiseau (FR)

(72) Inventors: Hervé CHABANNE, COURBEVOIE (FR); Linda GUIGA, PARIS (FR); Jean-Luc DANGER, ANTONY (FR)

(21) Appl. No.: 17/519,686

(22) Filed: Nov. 5, 2021

(30) Foreign Application Priority Data
Nov. 5, 2020 (FR) 20 11363

(51) Int. Cl. G06N 3/04

(52) U.S. Cl. CPC G06N 3/04

(57) ABSTRACT

Process and system for processing data by an artificial neural network comprising several pooling or convolutional layers all associated with neural matrices, including for each layer of the several successive layers obtaining a reordered matrix, obtaining a division of the reordered matrix into a plurality of contiguous submatrices having given widths and heights, and grouping execution of the individual operations to be performed for each submatrix.

### TECHNICAL FIELD

The invention relates to the field of data processing, in particular to the field of data processing by artificial neural networks.

### BACKGROUND

Convolutional neural networks are used to process data such as images.

In the present description, the term “neuron” is used to refer to an artificial neuron, and more specifically to the result of a neuron-specific computation.

Artificial neural networks may comprise so-called convolutional layers that are defined by applying a filter matrix to an input neuron matrix (from the previous layer in the network) to obtain a neuron matrix in the layer. Generally, each neuron of a convolutional layer is associated by its filter with a window of the neuron matrix of the previous layer in the network, which is called a receptive field. A receptive field thus comprises the neurons of the previous layer. Moving through the input neuron matrix of a convolutional layer also moves this receptive field.

For example, FIG. 1 shows two successive layers of neurons L1 and L2 of an artificial neural network. L2 is a neuron matrix of a convolutional layer that will process the values obtained by the previous matrix L1. The first neuron N11 of the layer L2 is configured to receive a value by applying a filter to the first window RC1 which contains the values I11, I12, I13, I21, I22, I31, I32, and I33. The filter is said to be a filter of size three (the filter height is three and the filter width is three). A dot product is then computed for this first neuron from all the values I11 to I33 and the filter associated with the neuron N11. The neuron N12 located to the right of the neuron N11 will be associated by its filter to a window which will be shifted to the right of the first window RC1 by a given step. The neuron N21 located below the neuron N11 will be associated with a window which will be shifted downward by this given step (or by another step) with respect to the first window RC1. It may be noted that the given step may be smaller than the filter size, so that windows that follow each other may overlap.

Convolutional neural networks also contain pooling layers wherein a neuron will also be associated with a window of values obtained by the previous layer. An example of a pooling layer neuron is a neuron that obtains the maximum value of the window it processes (max pooling).

It should be noted that the input data processed may have a depth, i.e., the input data processed may be matrices organized in the form of arrays or vectors having this depth, wherein case one will rather speak about value tensors. This is also the case for convolutional or pooling layers whose neurons and filters may have a depth that differs from that of the value tensors they process.

The implementation of convolutional layer processing involves a large number of multiplications to implement all dot products. The implementation of a convolutional layer is usually approached by the algorithm called general matrix multiply (GeMM). According to this algorithm, a reordered two-dimensional matrix is elaborated wherein each column corresponds to the values of one of said windows of the input matrix to be processed (if the matrix has a depth, the column contains all the values of the arrays/vectors belonging to the window), and a filter matrix is elaborated wherein each row corresponds to a filter of the convolutional layer (the width of this filter matrix corresponds to the product of the depth of the filter by the number of neurons present in each receptive field, the depth of the filter being equal to the depth of the processed data in input).

The algorithm then determines the dot product between each row of the filter matrix and each column of the reordered two-dimensional matrix. Although not technically correct, one also speaks of multiplication between a row of the filter matrix and a column of the reordered two-dimensional matrix.

The TensorFlow software library implements convolutional layers in this way.

It may be noted that the reordered two-dimensional matrix has a width equal to the number of receptive fields and a height equal to the number of values of the receptive field multiplied by the depth of this input matrix. The filter matrix has a height equal to the number of filters to be applied to the two-dimensional matrix, and thus to the depth of the convolutional layer (number of channels), and a width equal to the number of values of the receptive field multiplied by the depth of this input matrix.

A third party may implement attacks to determine the structure of convolutional neural networks. The possibility of implementing such attacks raises security concerns, in particular when convolutional neural networks are used to implement tasks in sensitive areas such as authentication or processing of user-specific information.

These attacks are often of the side-channel attack (SCA) type.

The earlier document “Cache telepathy: Leveraging shared resource attacks to learn DNN architectures” (M. Yan, C. W. Fletcher, and J. Torillas, CoRR, vol. abs/1808.04761, 2018) describes a side-channel attack wherein an attacker counts the number of matrix multiplications (i.e., what is implemented in the GeMM algorithm), determines the size of those matrices, and derives the size and number of filters.

In the earlier document “CSI neural network: Using side-channels to recover your artificial neural network information” (L. Batina, S. Bhasin, D. Jap, and S. Piceck, CoRR, vol. abs/1810.09076, 2018), it is described that once an attacker may distinguish between two neurons based on simple power analysis (SPA), it is possible to implement differential power analysis (DPA) to distinguish between the different layers.

It is thus understood that the use of the GeMM algorithm makes artificial neural networks with convolutional layers particularly vulnerable.

Other attacks have been described, in particular in the documents:

“Reverse engineering convolutional neural networks through side-channel information leaks” (W. Hua, Z. Zhang, and G. E. Suh, “Proceedings of the 55th Annual Design Automation Conference DAC 2018”, San Francisco, Calif., USA, Jun. 24-29, 2018, pp. 4:1-4:6, ACM, 2018);

“Security analysis of deep neural networks operating in the presence of cache side-channel attacks” (S. Hong, M. Davinroy, Y. Kaya, S. N. Locke, I. Rackow, K. Kulda, D. Dachman-Soled, and T. Dumitras, CoRR, vol. abs/1810.03487, 2018);

“How to Own NAS in your spare time” (S. Hong, M. Davinroy, Y. Kaya, D. Dachman-Soled, and T. Dumitras, CoRR, vol. abs/2002.06776, 2020);

“Stealing neural networks via timing side channels” (V. Duddu, D. Samanta, D. V. Rao, and V. E. Balas, CoRR, vol. abs/1812.11720, 2018);

“Open DNN box by power side-channel attack” (Y. Xiang, Z. Chen, Z. Chen, Z. Fang, H. Hao, J. Chen, Y. Liu, Z. Wu, Q. Xuan, and X. Yang, CoRR, vol. abs/1907.10406, 2019);

“Neural network model extraction attacks in edge devices by hearing architectural hints” (X. Hu, L. Liang, L. Deng, S. Li, X. Xie, Y. Ji, Y. Ding, C. Liu, T. Sherwood, and Y. Xie, CoRR, vol. abs/1903.03916, 2019).

For example, in the documents “Security analysis of deep neural networks operating in the presence of cache side-channel attacks” and “How to Own NAS in your spare time”, the attacker uses the Mastik platform by Yuval Yarompour to implement side-channel attacks on deep neural networks. In the document “Reverse engineering convolutional neural networks through side-channel information leaks”, memory accesses are monitored to determine the architecture of an artificial neural network.

Solutions to this problem have been discussed.

In particular, the document “Mitigating reverse engineering attacks on deep neural networks” (Y. Liu, D. Dachman-Soled, and A. Srivastava 2019 IEEE Computer Society Annual Symposium on VLSI, ISVLSI 2019, Miami, Fla., USA, Jul. 15-17, 2019, pp. 657-662, IEEE, 2019) proposes a solution to avoid the attack described in the document “Reverse engineering convolutional neural networks through side-channel information leaks”. This solution uses oblivious shuffle, address space layout randomization, and dummy memory accesses to hide the traces of memory accesses, while mitigating the required resources.

In the document “How to Own NAS in your spare time”, it is taught in particular that a random implementation of computations to counter attacks would have too great an impact on the resources required.

### SUMMARY

The present disclosure is related to a process for processing data by an artificial neural network comprising several successive layers of pooling or convolutional neurons all associated with input value tensors, and each neuron being associated with a receptive field of input values belonging to an input value tensor (MI1, MI2). The processing includes grouping executions of individual operations to obtain the values of neurons of several successive layers, each grouped execution comprising individual operations on a group of input values of an input value tensor, the values of this group of values being selected to correspond to a submatrix associated with this grouped execution, this submatrix being an extract resulting from a division of a so-called reordered matrix, associated with this input value tensor and wherein each column corresponds to a receptive field of input values of the input value tensor of the layer and each row of this column corresponds to a value of said receptive field of input values, the division of the reordered matrix being configured to divide the reordered matrix into a plurality of contiguous or overlapping (i.e., contiguous or even overlapping) submatrices having random widths and given heights, and the grouped executions being implemented according to:

an availability of the values of the submatrices of each grouped execution,

a given execution order of the submatrices of a same layer if the values of several submatrices are available,

and, if all the individual operations of a column of a reordered matrix have been executed, the value of one or more neurons corresponding to the receptive field of the column is obtained (for example, the receptive field may be specific to several neurons if the layer has a depth, but if the depth is 1 there is only one neuron for this receptive field).

This process may be implemented by a computer system, and the artificial neural network may be stored on a computer-readable storage medium.

Submatrices and reordered matrices are objects that may not be stored in a memory of the computer system implementing the data processing. On the other hand, the values of the selected groups of values must meet the following condition: to be able to fill a submatrix which, arranged with other submatrices of the same layer, will form a reordered matrix as defined above. In the present description, one may speak of the values of the submatrix which is technically incorrect, these values being those of a group of values.

For example, the identification of the selected values may be implemented in a preliminary step wherein the reordered matrices and submatrices are obtained. This identification may correspond to the use of arrays wherein these values will be stored little by little during the processing of the data by the network.

If the layer is a convolutional layer, the individual operations are, for example, the individual multiplications between each value of the submatrix and the corresponding filter value by which they are to be multiplied. Alternatively, an individual operation may refer to the individual multiplications and additions to be implemented for a column of a submatrix.

If the layer is a pooling layer, the individual operations may be down-samplings implemented for a submatrix column. For example, an individual operation may refer to obtaining the maximum value of a submatrix column.

It is considered that the input values and therefore the submatrices are available when they have been computed by processing the previous layer.

Also, the reordered matrix is reordered. There is not a simple multiplication of the reordered matrix by a filter matrix, at least for one convolutional layer.

Thus, the disclosure changes the order wherein the multiplications (if it is a convolutional layer) are implemented, and this order depends on how the groups of values are defined, in particular by means of divisions or splitting of reordered matrices into several submatrices.

The division into submatrices makes it possible to control the resources required to implement the invention on a computer system: fewer resources are used than if all the operations were performed randomly.

The random widths may have been previously defined in a random number generation step. In particular, at least two different widths may be used for the widths of the submatrices.

Overlapping submatrices may imply that individual computations are implemented several times, which is not an obstacle and makes it even more difficult to implement side-channel attacks. On the other hand, all values of a reordered matrix each belong to a submatrix (which is achieved by the contiguity or overlap of the submatrices).

It may be noted that the present invention differs from the data processing process described in the document “ISAAC: A convolutional neural network accelerator with in-situ analog arithmetic in crossbars” (A. Shafiee, A. Nag, N. Muralimanohar, R. Balasubramonian, J. P. Strachan, M. Hu, R. S. Williams, and V. Srikumar, 43rd ACM/IEEE Annual International Symposium on Computer Architecture, ISCA 2016, Seoul, South Korea, Jun. 18-22, 2016, pp. 14-26, IEEE Computer Society, 2016) in that submatrices of a reordered matrix are used. This document does not propose to divide a reordered matrix into submatrices, nor does it propose the order of execution of individual computations foreseen above.

In an aspect of the disclosure, the grouped executions are further implemented according to:
an order of execution of submatrices of different layers wherein a submatrix of a first layer is processed in priority to a submatrix of a second layer if the values of these submatrices are available and if the first layer is further from the input of the artificial neural network than the second layer.

Groups of values and thus submatrices should be selected that are small enough to ensure that values are available for a remote layer before all the individual operations of a less remote layer are performed.

For example, the groups of values may be selected so that there is at least one submatrix of a layer whose values may be available without all the values of the previous layer being available.

Here, the multiplications of one layer will be implemented before another layer preceding it in the network (the layers furthest from the network input are processed first), as long as the necessary values are available to implement the multiplications and there are no other ready submatrices of the same reordered matrix to be processed in the given order.

In an aspect of the disclosure, if the layer is a convolutional layer, said division of the reordered matrix is defined by a first ordered list of random values (one or more) of column numbers of the submatrices, and by a second ordered list of for example random values (one or more) of numbers of rows of the submatrices, so that in traversing the horizontally reordered matrix (i.e., from left to right, or from right to left), successive contiguous or overlapping submatrices have column numbers which are those of the first ordered list, and in traversing the vertically reordered matrix (i.e., from top to bottom, or from bottom to top), successive contiguous or overlapping submatrices have row numbers which are those of the second ordered list.

A technique may be chosen to elaborate random values. This elaboration is implemented prior to the data processing and in particular prior to the random executions.

Using random sizes makes it even more difficult to implement side-channel attacks to determine the structure of the neural network.

The use of the two ordered lists has the effect that for each submatrix, submatrix rows with all the same height are obtained, and submatrix columns with all the same width are obtained.

The number of values in each list is related to the size of the reordered matrix. For example, the sum of the widths of the first list is equal to the width of the reordered matrix, and the sum of the heights of the second list is equal to the height of the reordered matrix.

However, overlaps are possible between the submatrices, for example by a given horizontal and/or vertical overlap step. Applying this overlap may be implemented after the list has been developed.

In an aspect of the disclosure, the values of the first ordered list and the values of the second ordered list are all greater than 32 and/or multiples of 32.These values may be multiples of 32, insofar as the width and height of the reordered matrix allow for these values.

These values allow multiplications to be implemented in an optimal manner, using algorithms similar to GeMM.

In an aspect of the disclosure, if the layer is a pooling layer, the division of the reordered matrix is defined by an ordered list of random values of column numbers of the submatrices, such that in traversing the horizontally reordered matrix (i.e., from left to right, or from right to left), successive contiguous or overlapping submatrices have column numbers which are those of the first ordered list.

Pooling layers are associated with reordered matrix heights that are too small for a division in the height direction to be feasible. In fact, the size of a receptive field for a pooling layer is generally small, in particular because the depth is not used in the receptive field but is processed by different receptive fields. It is for this reason that a division of the reordered matrix into a single row of submatrices is feasible.

In an aspect of the disclosure, for at least one convolutional layer, prior to the grouped execution of the individual operations of at least one group of input values, a zero padding is implemented to increase the size of the group so that the size of the submatrix corresponding to this group increases.

This zero padding allows the implementation of dummy individual operations, which will make it even more difficult to implement side-channel attacks, because individual operations performed do not reflect the real structure of the reordered matrix (or of the layer).

In addition, zero padding allows for submatrices with dimensions that are multiples of 32.

In an aspect of the disclosure, an array is used wherein all results of individual operations (for example multiplications for a convolutional layer) are stored.

This aspect makes it possible to simply implement the individual operations at a first point in time and to use these values at a second point in time.

It will be noted that the values in this array may be accumulators for convolutional layers wherein all the new multiplications performed are added.

It may be noted that this array may have subarrays wherein the results of individual operations that have already been used are deleted to receive new results. The amount of memory required to process the data is thus limited. These subarrays may each correspond to a layer, or alternatively, the array may be divided into subarrays of the same size, the size being independent of the dimensions of the layers. Note that this alternative is advantageous because it makes covert channel attacks wherein memory addresses are monitored more difficult.

In an aspect of the disclosure, a counter is used for each submatrix to count the number of available values.

When this counter for each submatrix (one counter per submatrix) reaches a maximum equal to the number of values for the submatrix, a grouped execution may be implemented (respecting the given order of computation).

In an aspect of the disclosure, a counter is used for each neuron by means of which the number of individual operations performed for this neuron is counted.

It may be noted that for a convolutional layer, if an individual operation is a multiplication and additions for a submatrix column, then this counter reaches its maximum when it has reached a value equal to the number of submatrices arranged in column in the reordered matrix.

In an aspect of the disclosure, if the layer is a convolutional layer, the addresses of the values of each filter usable in the individual operations of each submatrix are stored in an array.

These addresses may be indices indicating positions in an array. In particular, the values of each filter may be read into a filter row (for example an array) and the positions in that row/array are themselves stored in an array. In fact, an address may indicate the first value of each filter that may be used for the individual operations of each submatrix.

It will be noted that in this case, a filter line may be a filter line such as those used in the GeMM algorithm.

In an aspect of the disclosure, the process comprises obtaining said groups of input values.

This step may comprise the identification of input values which verify the conditions of membership of submatrices of reordered matrices, these submatrices being extracts resulting from a division of reordered matrices each reordered matrix being associated with an input value tensor and wherein each column corresponds to a receptive field of input values of the input value tensor of the layer and each row of that column corresponds to a value of said receptive field of input values, the division of the reordered matrix being configured to divide the reordered matrix into a plurality of contiguous or overlapping submatrices having random widths and given heights.

The identification of the input values may use addresses where the input values will be stored and/or use an ordered list of column numbers of the submatrices and/or use an ordered list of row numbers of the submatrices. If ordered lists of columns or rows are used, said addresses may be derived from these lists.

In an aspect of the disclosure, for at least one layer, the obtaining of one of said groups of input values is implemented when the counter specific to the submatrix corresponding to said one of the groups of input values, reaches a maximum equal to the number of values of the submatrix.

The disclosure also provides a process for preparing an artificial neural network configured to process data and comprising several successive layers of pooling or convolutional neurons all associated with input value tensors, each neuron being associated with a receptive field of input values belonging to an input value tensor, the preparation process comprising for each layer of the several successive layers: obtaining groups of input values comprising an identification of the input values which verify the conditions of belonging to submatrices of reordered matrices, these submatrices being extracts resulting from a division of reordered matrices, each reordered matrix being associated with an input value tensor and wherein each column corresponds to a receptive field of input values of the input value tensor of the layer and each line of this column corresponds to a value of said receptive field of input values, the division of the reordered matrix being configured to divide the reordered matrix into a plurality of contiguous or overlapping submatrices having random widths and given heights,
configuring the artificial neural network to perform individual operations in a grouped fashion to obtain the neural values of the plurality of successive layers, each grouped execution comprising the individual operations on a group of input values, the grouped executions being implemented according to:

an availability of the values of the submatrices of each grouped execution,

a given order of execution of the submatrices of a same layer if the values of several submatrices are available,
and, if all the individual operations of a column of a reordered matrix have been executed, the value of one or more neurons corresponding to the receptive field of the column is obtained.

This process may provide an artificial neural network that may be used in any of the aspects of the disclosure related to the data processing process as described above.

In this process, the artificial neural network is not processed, but is prepared for subsequent processing.

In an aspect of the disclosure, this process comprises, for each layer of several successive layers, obtaining a reordered matrix associated with the input value tensor of the layer, wherein each column corresponds to a receptive field of input values of the input value tensor of the layer and each row of that column corresponds to a value of said receptive field of input values, dividing the reordered matrix into a plurality of contiguous or overlapping submatrices having random widths and given heights, each submatrix comprising groups of input values of the input value tensor.

The disclosure also provides a system for processing data using an artificial neural network of the system, the network comprising several successive layers of pooling or convolutional neurons all associated with input value tensors, each neuron being associated with a receptive field of input values belonging to an input value tensor, wherein the processing is implemented by grouped executions of individual operations to obtain the values of neurons of several successive layers, each grouped execution comprising individual operations on a group of input values of an input value tensor, the values of this group of values being selected to correspond to a submatrix associated with this grouped execution, this submatrix being an extract resulting from a division of a so-called reordered matrix, associated with that input value tensor and wherein each column corresponds to a receptive field of input values of the input value tensor of the layer and each row of that column corresponds to a value of said receptive field of input values, the division of the reordered matrix being configured to divide the reordered matrix into a plurality of contiguous or overlapping submatrices having random widths and given heights, and the grouped executions being implemented according to:

an availability of the values of the submatrices of each grouped execution,

a given order of execution of the submatrices of a same layer if the values of several submatrices are available,

and, if all the individual operations of a column of a reordered matrix have been executed, the value of one or more neurons corresponding to the receptive field of the column is obtained.

This system may be a computer system.

This system may be configured to implement all the aspects of the disclosure related to the process as defined above.

In particular, this system may implement the obtaining of groups of input values.

The disclosure also provides a system for preparing an artificial neural network configured to process data and comprising several successive layers of pooling or convolutional neurons all associated with input value tensors, each neuron being associated with a receptive field of input values belonging to an input value tensor, the preparation system comprising, for each layer of the several successive layers: a module for obtaining, for each layer of the several successive layers, groups of input values comprising an identification of the input values which verify the conditions of belonging to submatrices of reordered matrices, these submatrices being extracts resulting from a division of reordered matrices, each reordered matrix being associated with an input value tensor and wherein each column corresponds to a receptive field of input values of the input value tensor of the layer and each row of this column corresponds to a value of said receptive field of input values, the division of the reordered matrix being configured to divide the reordered matrix into a plurality of contiguous or overlapping submatrices having random widths and given heights.
a module for configuring the artificial neural network to perform individual operations to obtain the neural values of the plurality of successive layers in a grouped fashion, each grouped execution comprising the individual operations on a group of input values, the grouped executions being implemented according to:

an availability of the values of the submatrices of each grouped execution,

a given order of execution of the submatrices of a same layer if the values of several submatrices are available,
and, if all the individual operations of a column of a reordered matrix have been executed, the value of one or more neurons corresponding to the receptive field of the column is obtained.

This system makes it possible to obtain artificial neural networks that may be used in all the aspects of the disclosure related to the data processing process defined above.

It may be noted that this system does not implement data processing, but only preparation.

The disclosure also provides a computer program having instructions for performing the steps of a data processing process as defined above when said program is executed by a computer and a computer program having instructions for performing the steps of a neural network preparation process as defined above when said program is executed by a computer.

Note that the computer programs referred to in the present disclosure may use any programming language, and may be in the form of source code, object code, or code intermediate between source code and object code, such as in partially compiled form, or in any other desirable form.

The disclosure also provides a computer-readable storage medium on which is stored a computer program comprising instructions for performing the steps of a data processing process as defined above and a computer-readable storage medium on which is stored a computer program comprising instructions for performing the steps of a neural network preparation process as defined above.

The storage (or information) media referred to in the present disclosure may be any entity or device capable of storing the program. For example, the medium may comprise a storage medium, such as a ROM, for example, CD ROM or microelectronic circuit ROM, a rewritable non-volatile memory, for example, FLASH or EEPROM, or a magnetic storage medium, for example, a floppy disk or a hard disk.

On the other hand, the storage media may correspond to a transmissible medium such as an electrical or optical signal, which may be conveyed via an electrical or optical cable, by radio or by other means. The program according to the disclosure may in particular be downloaded on an Internet-type network.

Alternatively, the storage media may correspond to an integrated circuit wherein the program is incorporated, the circuit being adapted to execute or to be used in the execution of the process in question.

It will be noted that the artificial neural network, said matrices and submatrices, may be stored in the storage medium.

The present disclosure improves the security of convolutional neural networks, by making it difficult to implement a side-channel attack, while limiting the amount of resources required.

### BRIEF DESCRIPTION OF THE DRAWINGS

Other features and advantages of the present disclosure will emerge from the description provided below, with reference to the appended drawings which illustrate a non-limiting example.

In the figures:

FIG. 1 shows an exemplary illustration of a convolutional layer.

FIG. 2 shows an exemplary illustration of an implementation of an embodiment of the disclosure.

FIG. 3 shows another exemplary illustration of an implementation of an embodiment of the disclosure.

FIG. 4 shows an example wherein zero padding is implemented.

FIG. 5 shows an exemplary schematic representation of the steps of a process according to an example.

FIG. 6 shows an exemplary schematic representation of a system according to an example.

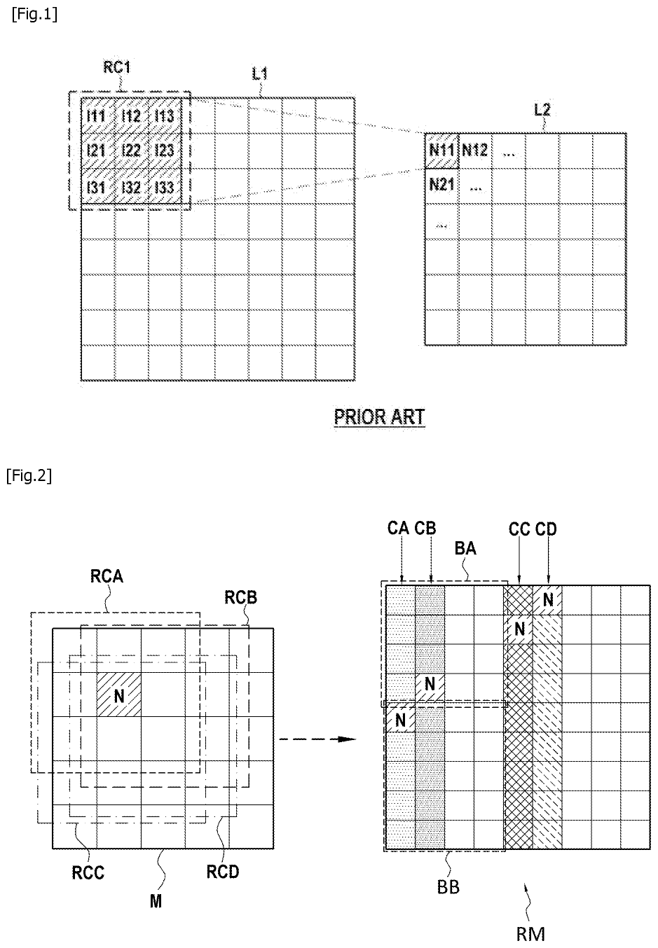

### DETAILED DESCRIPTION

A process and a system for processing by an artificial neural network that comprises several successive pooling or convolutional layers will now be described. The obtaining of the artificial neural networks that will be used will also be described.

In the examples described below and for greater simplicity, small dimensional matrices are used rather than tensors. However, the invention is applicable to the processing of data in the form of tensors (for example RGB images).

The data processing is implemented in such a way as to avoid a side-channel attack, such as, for example, an attack of the type described in “Cache telepathy: Leveraging shared resource attacks to learn DNN architectures”.

In order to avoid attacks, the processes and systems described below change the order wherein the individual computations (in particular multiplications) of each layer are performed, respecting a partly random division of the intermediate matrices used for computation purposes called reordered matrices into a plurality of submatrices, and then implementing the individual computations in a grouped manner.

For example, for a convolutional layer, an individual computation is a multiplication or, alternatively, the combination of multiplications and additions for the values in a submatrix column.

Referring to FIG. 2, an input matrix M of a convolutional layer is shown. This input matrix may be obtained after processing by a convolutional layer that precedes it in a convolutional neural network. In fact, each value in the matrix is here the result of a convolutional and is associated with a neuron.

To implement the process according to the invention, the matrix M of input values is reordered into a matrix RM for the convolutional layer concerned, wherein the receptive field of each neuron covers 3×3 values of the matrix M, and the shift of the receptive field is 1 (vertically and horizontally). This operation is implemented in a manner known per se as used in the GeMM algorithm.

In this figure, four receptive fields are designated by the references RCA, RCB, RCC, and RCD. In the reordered matrix, the receptive fields RCA, RCB, RCC, and RCD correspond respectively to the columns CA, CB, CC, and CD. This figure shows the shift of the receptive field of one between the receptive fields RCA, RCB, RCC, and RCD.

It may be noted that when the neuron N of the matrix M has been computed to become an available input value by a convolutional operation (if the preceding layer is a convolutional layer), its value is available, and it may be used in the four columns CA, CB, CC, and CD.

The availability of the values may also be followed with a counter associated with each neuron of the matrix RM to trigger the computation of a neuron associated with the column and the associated receptive field (by way of indication, if the layer has a depth, several computations of neurons associated with the column may be triggered).

In contrast, in the disclosure, the individual operations (multiplications, or multiplications and additions for a convolutional layer) for the reordered matrix are performed in a grouped fashion for each submatrix.

In the figure, two submatrices BA and BB have been represented. It may be seen that the neuron N appears in these two submatrices. A counter specific to each submatrix may be used to trigger the grouped execution when the counter indicates that all the values of the submatrix are available (this counter is incremented each time a new value is available in the associated submatrix).

It will be noted that the submatrices BA and BB do not overlap, but that this is still possible.

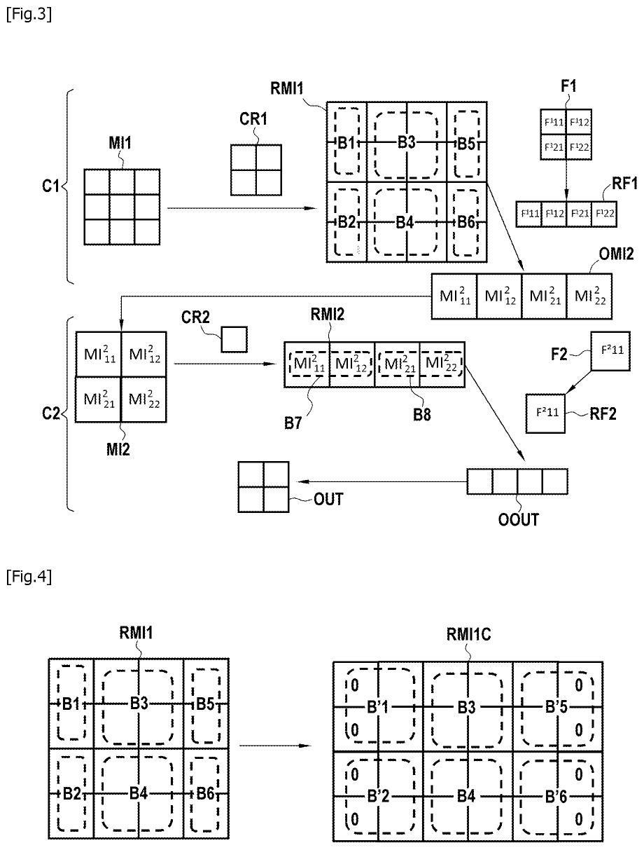

The division into submatrices will be described in more detail with reference to FIG. 3.

In FIG. 3, a convolutional artificial neural network with two layers is shown: a convolutional layer C1 of 4 OM12 neurons and a filter F1 of size 2×2, and a convolutional layer C2 of 4 OOUT neurons and a filter F2 of size 1×1. The input to the neural network is an image MI1 of size 3×3×1 (the depth is 1, for example the input is a monochrome image).

In this figure, reference C1 refers to the first layer, i.e., the application of filters to an input value matrix, and reference C2 refers to the second layer, i.e., the application of filters to the matrix that contains the neurons computed by the first layer.

In order to implement an aspect of the disclosure, reordered matrices with previously developed submatrices will be used or, alternatively, when they are used (for example when a submatrix value is available, the values that will belong to the submatrix will be identified). In addition, the following elements will be used:

ACC: an array wherein all the results of the individual operations are stored (more precisely, here the multiplications and additions for the values of each submatrix column);

B_C: a counter specific to each submatrix by means of which the number of available values are counted;

C_C: a counter specific to each neuron by means of which the number of individual operations performed for this neuron is counted; and

I_B: an array wherein the addresses (here indices) of the subfilters (the portion of a filter of interest for a submatrix) usable in the individual operations of each submatrix are stored.

Here, the array ACC has seventeen values (3×3+2*2+2*2). In fact, there are 3×3 values each associated with one of the input data (the input image MI1 is of size 3×3×1), there are 2×2 values each associated with one of the four output neurons of the layer C1 (i.e., the four neurons of OMI2), and there are 2×2 values each associated with one of the four output neurons of the layer C2 (i.e., the four output neurons of OOUT).

There are also seventeen counters C_C. One for each element of the array ACC. The counters C_C associated with the first nine values of the array ACC may be filled with a value indicating that all the individual operations have been performed to compute these neurons, for example with the value “3” if it is considered that three individual operations are required for these neurons to be available.

In the figure, the input matrix MI1 and its reordered form RMI1 are represented for the convolutional layer C1. The reordered matrix RMI1 has four columns (there are four receptive fields here) of four values (the neurons of the layer C1 have a receptive field CR1 of 2×2 values, and the input tensor has a depth of one).

To implement a division of the reordered matrix RMI1, two ordered lists of random values are obtained:

L11: {1, 2, 1}, and

L12: {2, 2}.

The list L11 contains random values of column numbers for submatrices and the list L12 contains random values of row numbers for submatrices, these submatrices resulting from the division of the reordered matrix RMI1.

Any method for generating random numbers may be used, using constraints such as a check of the sum of the number of columns which must not exceed the number of columns of the reordered matrix RMI1, and a check of the sum of the number of rows which must not exceed the number of rows of the reordered matrix RMI1.

In the matrix RMI1, there are horizontally, here from left to right (this reading order being fixed beforehand), and on the same row, a submatrix with a width of one column, a submatrix with a width of two columns, and a submatrix with a width of one column. There is also, on the same column, vertically and here from top to bottom (this reading order being fixed beforehand) a submatrix having a height of two lines, and a submatrix having a height of two lines. The division obtained is represented in the figure, from top to bottom and then from left to right (this is the order given associated with this division into submatrices), with a representation of the submatrix B1 (1×2), the submatrix B2 (1×2), the submatrix B3 (2×2), the submatrix B4 (2×2), the submatrix B5 (1×2), and the submatrix B6 (1×2)

For this division, there will also be six counters B_C, one for each submatrix, which will count the number of values available in each submatrix and may trigger the grouped execution of the individual operations to be performed for each submatrix. For example, for submatrix B3, this counter counts the values until it reaches “4,” and the grouped execution of the individual operations to be performed for this submatrix may be triggered if the counter has reached the value “4.”

The filter F1 of the convolutional layer C1 is reordered as a filter matrix RF1. The filter F1 is thus presented as a filter matrix RF1 of size 1×4. The position in this filter matrix of the filters to be used for the submatrices is then determined. The submatrices may then be multiplied by the filters of the matrix RF1 whose width is equal to the height of the submatrix.

In fact, for the matrix RMI1, the addresses of the filter values usable in the individual operations of each submatrix (i.e., the values of the filter matrix RF1 by which the values in the submatrices will be multiplied) may be stored in an array. This array indicates the first filter element to be used in the multiplication of a submatrix by a part of the filter matrix RF1. In the figure, the values of the filter F1, and therefore of the filter matrix RF1, have been identified by the references F¹11,

F¹12, F¹21, and F¹22. The array may contain the index 0 and index 2 to indicate that for each submatrix located at the top, during the grouped execution, the values F¹11 and F¹12 (which start at index 0in the filter matrix RF1) will therefore be used. For each submatrix located at the bottom, during the grouped execution, the values F¹21 and F¹22 (which start at index 2 in the filter matrix RF1) will be used.

For each neuron MI²₁₁, MI²₁₂, MI²₂₁, MI²₂₂ (associated respectively to the layer filter F1), there will be a counter C_C which, when it reaches the value 2, indicates that the computation of the associated neuron is completed (since each column of the reordered matrix RM1 is here divided into two submatrices. The computation of each neuron of the convolutional layer C1 thus requires two grouped executions of the individual operations: one for each of the two submatrices containing the column associated with the neuron). The values of the neurons of the first layer MI²₁₁, MI²₁₂, MI²₂₁, MI²₂₂ are thus obtained.

In the reordered matrix RMI1, all values are already available since they come from the input, this may be seen in the counters B_C.

The data processing is then implemented as follows. The matrix RMI1 is run submatrix by submatrix in the order B1 to B6, with the multiplications of each submatrix being performed in a grouped manner.

For the submatrix B1, a portion of the matrix RF1 starting at index 0 is multiplied with the column of the submatrix B1. At this stage, the counter C_C of the first neuron of the layer C1 (MI²₁₁) takes the value 1. For the submatrix B2, a portion of the matrix RF1 starting at index 2 is multiplied with the column of the submatrix B2. At this stage, the counter C_C of the first neuron of the layer C1 is incremented by 1 and takes the value 2.

By these multiplications and using the accumulator ACC associated with the neuron MI²₁₁, the value of the neuron MI²₁₁ may be obtained.

A neuron value becomes available in the second input matrix MI2 represented in the figure and obtained from OM12, which may be reordered into the matrix RMI2. This first neuron computation makes the first value available (the one on the left in the matrix RMI2).

It may be noted that here, a 1×1 value receptive field designated by the reference CR2 has been used to reorganize the matrix MI2 into the matrix RMI2.

The division of the reordered matrix RMI2 may be done with the following two ordered lists of random values:

L21: {2, 2}, and

L22: {1, 1}.

The two submatrices B7 and B8 are referenced in the figure. Here, in block B7, there is one value, which is less than the two expected (counter B_C), and it is therefore necessary to return to the processing of RMI1.

The submatrix B3, then the submatrix B4, may then be processed. To this end, the array I_B may be used to find the indices of the values of RF1 to be used.

It may be noted that after the implementation of the grouped computations of the submatrices B3 and B4, two other neurons of the layer C1, MI²₁₂ and MI²₂₁, i.e., two other values of the matrix MI2 are available (counters C_C). This time, B7 has all its values available (counter B_C), and the multiplications associated with it may be implemented. These multiplications have priority over those of submatrices B5 and B6 because the layer C2 is further away from the input of the neural network. This embodiment is advantageous because it mixes the computations of different layers.

The output matrix OUT (2×2) thus begins to fill with two values (via the output matrix OOUT).

The process continues until all values of the output matrix OUT have their four values available.

FIG. 4 demonstrates an exemplary representation of an optional zero padding step.

Starting from the reordered matrix RMI1 described above with reference to FIG. 3, all the submatrices may be modified so that they all have a size of 2×2 to obtain the submatrices B′1, B′2, B3 (B3 has not been modified and the same reference is kept), B4 (B4 has not been modified and the same reference is kept), B′S and B′6. This gives the completed reordered matrix RMI1C.

As may be seen, the location of the zeros in the submatrices does not matter as long as the values that were present in the matrix RMI1 are multiplied by the correct filter values. The processing by the layer C1 will be similar to the one described above and the results obtained will not be affected by the presence of zeros. On the other hand, in the case of a side-channel attack, additional multiplications will be observed which do not reflect the structure of the layer C1.

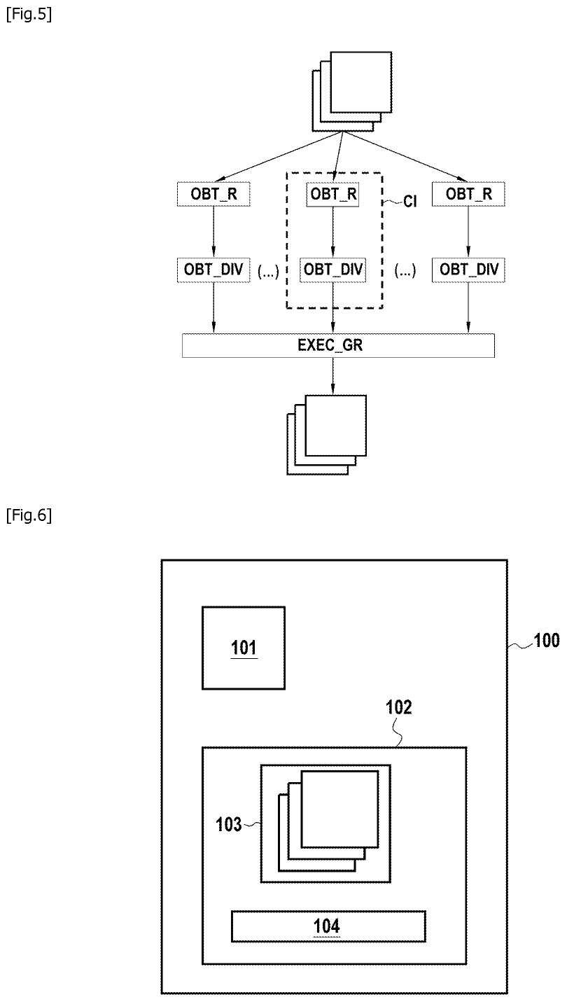

FIG. 5 shows an exemplary schematic representation of a process for preparing an artificial neural network to obtain for example the network shown in FIG. 3. Here, the network comprises several successive pooling or convolutional layers all associated with neural matrices, each neuron being associated with a receptive field of input values belonging to a matrix of input values.

For this process, the results of the reordered matrices and submatrices are shown. This is presented only by way of indication, since it is possible to identify the values that form these reordered matrices/submatrices by their addresses, without having to elaborate the reordered matrices and submatrices. In fact, this corresponds to identifying values (for example by using their addresses and/or by using an ordered list of numbers of columns of the submatrices and/or by using an ordered list of numbers of rows of the submatrices) so that these values may form the submatrices and the reordered matrices.

Here, all layers of the artificial neural network will be processed with the same steps. For example, for the layer CI, the following are implemented:

an obtaining OBT_R of a reordered matrix associated with the input value tensor of the layer, wherein each column corresponds to a receptive field of input values of the input value tensor of the layer and each row of this column corresponds to a value of said receptive field of input values,

a division (OBT_DIV) of the reordered matrix into a plurality of contiguous or overlapping submatrices having given random widths and heights, each submatrix comprising groups of input values of the input value tensor,

the artificial neural network being configured (EXEC_GR) to perform individual operations to obtain the neural values of the plurality of successive layers in a grouped manner, each grouped execution comprising the individual operations on a group of values of one of said submatrices, the grouped executions being implemented according to:

an availability of the values of the submatrices of each grouped execution,

a given execution order of the submatrices of a same layer if the values of several submatrices are available, and, if all the individual operations of a column of a reordered matrix have been executed, the value of one or more neurons corresponding to the receptive field of the column is obtained.

A new implementation of the artificial neural network is thus obtained.

FIG. 6 demonstrates an exemplary schematic representation of a computer system 100 configured to implement the process shown in FIG. 5.

The computer system 100 is a system for preparing an artificial neural network.

To implement this process, the system 100 comprises a processor 101 on which computer program instructions stored in a non-volatile memory 102 may be executed.

In this non-volatile memory, the artificial neural network 103 is stored. This network comprises several successive pooling or convolutional layers all associated with neural matrices, each neuron being associated with a receptive field of input values belonging to a matrix of input values.

Also, in the non-volatile memory 102, instructions 104 have been stored to prepare the artificial neural network 103 and obtain an implementation as obtained from the process described with reference to FIG. 5.

The systems and processes described above make it more difficult to implement side-channel attacks.

They therefore allow the use of artificial neural networks for data processing in the field of security (for example when the data are images, possibly for the authentication of documents or persons).

1. A process for processing data by an artificial neural network, wherein the artificial neural network includes several successive layers of pooling or convolutional neurons all associated with input value tensors, each neuron being associated with a receptive field of input values belonging to an input value tensor, the process comprising:
executing as a group a plurality of individual operations to obtain a value of neurons of the several successive layers, wherein each grouped execution comprises of individual operations on a group of input values of an input value tensor, wherein the values of this group of values are selected to correspond to a submatrix associated with the grouped execution, wherein the submatrix is an extract resulting from a division of a reordered matrix associated with the input value tensor and wherein each column of the reordered matrix corresponds to a receptive field of input values of the input value tensor of the layer and each row of the column corresponds to a value of the receptive field of input values, wherein the division of the reordered matrix is configured to divide the reordered matrix into a plurality of contiguous or overlapping submatrices having random widths and given heights, wherein the grouped executions are implemented according to an availability of the values of the submatrices of each grouped execution, and a given order of execution of the submatrices of a same layer if the values of several submatrices are available, and wherein, if all the individual operations of a column of a reordered matrix have been executed, the value of one or more neurons corresponding to the receptive field of the column is obtained.

2. The process of claim 1, wherein the grouped executions are further implemented according to an order of execution of submatrices of different layers wherein a submatrix of a first layer is processed in priority to a submatrix of a second layer if the values of these submatrices are available and if the first layer is further from the input of the artificial neural network than the second layer.

3. The process for processing data by an artificial neural network of claim 1, wherein if the layer is a convolutional layer, the division of the reordered matrix comprises a first ordered list of random values of column numbers of the submatrices, and by a second ordered list of random values of numbers of rows of the submatrices such that, in traversing the horizontally reordered matrix, the successive contiguous or overlapping submatrices have column numbers which are those of the first ordered list, and in traversing the vertically reordered matrix, the successive contiguous or overlapping submatrices have row numbers which are those of the second ordered list.

4. The process for processing data by an artificial neural network of claim 3, wherein the values of the first ordered list and the values of the second ordered list are all greater than 32 and/or multiples of 32.

5. The process for processing data by an artificial neural network of claim 1, wherein if the layer is a pooling layer, the division of the reordered matrix is comprised of an ordered list of random values of column numbers of the submatrices, such that in traversing the horizontally reordered matrix, the successive contiguous or overlapping submatrices have column numbers which are those of the first ordered list.

6. The process for processing data by an artificial neural network of claim 3, wherein for the at least one convolutional layer, prior to the grouped execution of the individual operations of at least one group of input values, zero padding is implemented to increase the size of the group so that the size of the submatrix corresponding to this group increases.

7. The process for processing data by an artificial neural network of claim 1, wherein an array is used wherein all results of individual operations are stored.

8. The process for processing data by an artificial neural network of claim 1, wherein a counter is used which is specific to each submatrix and by means of which the number of available values is counted.

9. The process for processing data by an artificial neural network of claim 8, wherein a counter specific to each neuron is used by means of which the number of individual operations performed for that neuron is counted.

10. The process for processing data by an artificial neural network of claim 1, wherein if the layer is a convolutional layer, an address of the values of each filter usable in the individual operations of each submatrix are stored in an array.

11. The process for processing data by an artificial neural network of claim 10, further comprising obtaining the groups of input values.

12. The process for processing data by an artificial neural network of claim 11, wherein, for at least one layer, the obtaining of one of the groups of input values is implemented when the counter specific to the submatrix corresponding to the groups of input values reaches a maximum equal to a number of values of the submatrix.

13. A process for preparing an artificial neural network configured to process data and for each layer of several successive layers of pooling or convolutional neurons all associated with input value tensors, each neuron being associated with a receptive field of input values belonging to an input value tensor, the process comprising:
obtaining groups of input values, comprising identifying the input values that verify a condition of belonging to a submatrice of a plurality of reordered matrices, wherein the submatrices are extracts resulting from a division of the reordered matrices, wherein each reordered matrix is associated with an input value tensor and wherein each column of the reordered matrix corresponds to a receptive field of input values of the input value tensor of the layer and each row of the column corresponds to a value of the receptive field of input values, wherein the division of the reordered matrix are configured to divide the reordered matrix into a plurality of contiguous or overlapping submatrices having random widths and given heights; and
configuring the artificial neural network to perform individual operations to obtain a plurality of neural values of the successive layers in a grouped fashion, wherein each grouped execution is comprised of the individual operations on a group of input values, wherein the grouped executions are implemented according to an availability of the values of the submatrices of each grouped execution and a given order of execution of the submatrices of a same layer if the values of several submatrices are available, and wherein, if all the individual operations of a column of a reordered matrix have been executed, the value of one or more neurons corresponding to the receptive field of the column is obtained.

14. The process for preparing an artificial neural network of claim 13, further comprising for each layer of the several successive layers, obtaining a reordered matrix associated with the input value tensor of the layer, wherein each column of the reordered matrix corresponds to a receptive field of input values of the input value tensor of the layer and each row of the column corresponds to a value of the receptive field of input values, and dividing the reordered matrix into a plurality of contiguous or overlapping submatrices having random widths and given heights, wherein each submatrix comprising groups of input values of the input value tensor.

15. A system for processing data using an artificial neural network of the system, wherein the network includes several successive layers of pooling or convolutional neurons all associated with input value tensors, each neuron being associated with a receptive field of input values belonging to an input value tensor, the system comprises:
a computer-readable storage medium on which is stored a computer program comprising instructions for:
executing as a group a plurality of individual operations to obtain the values of neurons of several successive layers, wherein each grouped execution is comprised of individual operations on a group of input values of an input value tensor, wherein the values of the group of values is selected to correspond to a submatrix associated with the grouped execution, wherein the submatrix is an extract resulting from a division of a reordered matrix associated with the input value tensor and wherein each column of the reordered matrix corresponds to a receptive field of input values of the input value tensor of the layer and each row of the column corresponds to a value of the receptive field of input values, wherein the division of the reordered matrix is configured to divide the reordered matrix into a plurality of contiguous or overlapping submatrices having given random widths and heights, and wherein the grouped executions are implemented according to an availability of the values of the submatrices of each grouped execution and a given order of execution of the submatrices of a same layer if the values of several subarrays are available, and wherein, if all the individual operations of a column of a reordered matrix have been executed, the value of one or more neurons corresponding to the receptive field of the column is obtained.

16. The system for processing data using an artificial neural network of the system of claim 15, wherein if the layer is a convolutional layer, the division of the reordered matrix comprises a first ordered list of random values of column numbers of the submatrices and a second ordered list of random values of numbers of rows of the submatrices such that, in traversing the horizontally reordered matrix, the successive contiguous or overlapping submatrices have column numbers which are those of the first ordered list, and in traversing the vertically reordered matrix, the successive contiguous or overlapping submatrices have row numbers which are those of the second ordered list.

17. The system for processing data using an artificial neural network of the system of claim 16, wherein the values of the first ordered list and the values of the second ordered list are all at least one of greater than 32 and multiples of 32.

18. The system for processing data using an artificial neural network of the system of claim 15, wherein if the layer is a pooling layer, the division of the reordered matrix is comprised of an ordered list of random values of column numbers of the submatrices, such that in traversing the horizontally reordered matrix, the successive contiguous or overlapping submatrices have column numbers which are those of the first ordered list.

19. A system for preparing an artificial neural network configured to process data for each layer of several successive layers of pooling or convolutional neurons all associated with input value tensors, each neuron being associated with a receptive field of input values belonging to an input value tensor, the system comprising:
a computer-readable storage medium on which is stored a computer program comprising instructions for:
obtaining, for each layer of the several successive layers, groups of input values, comprising identifying the input values that verify a condition of belonging to a submatrice of a plurality of reordered matrices, wherein the submatrices are extracts resulting from a division of the reordered matrices, wherein each reordered matrix is associated with an input value tensor and wherein each column of the reordered matrix corresponds to a receptive field of input values of the input value tensor of the layer and each row of this column corresponds to a value of the receptive field of input values, wherein the division of the reordered matrix is configured to divide the reordered matrix into a plurality of contiguous or overlapping submatrices having random widths and given heights;
configuring the artificial neural network to perform individual operations to obtain a plurality of neural values of the successive layers in a grouped fashion, wherein each grouped execution is comprised of the individual operations on a group of input values, wherein the grouped executions are implemented according to an availability of the values of the submatrices of each grouped execution and a given order of execution of the submatrices of a same layer if the values of several submatrices are available, and wherein, if all the individual operations of a column of a reordered matrix have been executed, the value of one or more neurons corresponding to the receptive field of the column is obtained.

20. The system for preparing an artificial neural network configured to process data of claim 19, further comprising for each layer of the several successive layers, obtaining a reordered matrix associated with the input value tensor of the layer, wherein each column corresponds to a receptive field of input values of the input value tensor of the layer and each row of that column corresponds to a value of the receptive field of input values, dividing the reordered matrix into a plurality of contiguous or overlapping submatrices having random widths and given heights, where each submatrix is comprised of groups of input values of the input value tensor.
